(19) United States
(12) Patent Application Publication
(10) Pub. No.: US 2026/0201920 A1
(43) Pub. Date: Jul. 16, 2026

(54) LOCKING DEVICE AND ASSEMBLY

(71) Applicant: FOXCONN INTERCONNECT TECHNOLOGY LIMITED, Grand Cayman (KY)

(72) Inventors: TING ZHU, Shenzhen (CN); MING-LUN SZU, New Taipei (TW); FU-JIN PENG, Kunshan (CN)

(21) Appl. No.: 19/444,773

(22) Filed: Jan. 9, 2026

(30) Foreign Application Priority Data
Jan. 10, 2025 (CN) 202510042327.3

(51) Int. Cl. F16B 21/02

(52) U.S. Cl. CPC F16B 21/02

(57) ABSTRACT

A locking device includes a sleeve, a locking member, a restricting member, and a resilient member. The sleeve has an assembly through hole extending through the sleeve along an axial direction, a restricting through hole formed on a side face of the sleeve and in fluid communication with the assembly through hole, and an accommodating portion arranged at an end face of the sleeve. The locking member is movably assembled in the restricting through hole. The restricting member comprises a first guide portion rotatably assembled in the assembly through hole, and a restricting protrusion configured to rotate on the end face of the sleeve to the accommodating portion. The resilient member is configured to drive the restricting protrusion into the accommodating portion, and the first guide portion is configured to push the locking member to move in the restricting through hole away from the axis of the sleeve.

### BACKGROUND OF THE INVENTION

### Field of the Invention

The present invention relates to an equipment assembly, particularly to a locking device and assembly.

### Description of Related Arts

In fields such as mechanical engineering and electronic product assembly, using screws and nuts is a widely used method for fastening connections. Through the cooperation of screws and nuts, reliable fixing between two or more components can be achieved and the tightening force can be flexibly adjusted according to actual needs. Namely, different tightening forces can be provided by adjusting the number of turns of the screw and nut. The locking structure formed by screws and nuts is inexpensive and suitable for various scenarios.

However, the tightening process of screws and nuts requires tools such as screwdrivers, and certain types of screws and nuts require specific tools, increasing the complexity of the tightening operation and reducing work efficiency.

### SUMMARY OF THE INVENTION

A locking device includes a sleeve, a locking member, a restricting member, and a resilient member. The sleeve has an assembly through hole and a restricting through hole. The assembly through hole extends through the sleeve along an axial direction of the sleeve, the restricting through hole is formed on a side face of the sleeve and is in fluid communication with the assembly through hole, and an end face of the sleeve has an accommodating portion. The locking member is movably assembled in the restricting through hole. The restricting member includes a first guide portion and a restricting protrusion connected to each other. The first guide portion is rotatably assembled in the assembly through hole, at least a portion of the first guide portion is aligned to the restricting through hole, the restricting protrusion abuts an end of the sleeve, and the restricting protrusion is configured to rotate on the end face of the sleeve to the accommodating portion as the restricting member rotates. The resilient member is installed in a chamber formed by the restricting member and the sleeve. The resilient member is configured to apply a force to the sleeve to move the restricting protrusion into the accommodating portion, and the first guide portion is configured to push the locking member to move in the restricting through hole in a direction away from the axis of the sleeve.

An assembly includes a locking device and at least two locking target units. The locking device includes a sleeve, a locking member, a restricting member, and a resilient member. The sleeve has an assembly through hole and a restricting through hole. The assembly through hole extends through the sleeve along an axial direction of the sleeve, the restricting through hole is formed on a side face of the sleeve and is in fluid communication with the assembly through hole, and an end face of the sleeve has an accommodating portion. The locking member is movably assembled in the restricting through hole. The restricting member includes a first guide portion and a restricting protrusion connected to each other. The first guide portion is rotatably assembled in the assembly through hole, at least a portion of the first guide portion is aligned to the restricting through hole, the restricting protrusion abuts an end of the sleeve, and the restricting protrusion is configured to rotate on the end face of the sleeve to the accommodating portion as the restricting member rotates. The resilient member is installed in a chamber formed by the restricting member and the sleeve. The resilient member is configured to apply a force to the sleeve to move the restricting protrusion into the accommodating portion, and the first guide portion is configured to push the locking member to move in the restricting through hole in a direction away from the axis of the sleeve. The at least two locking target units are stacked together, and each locking target unit has a hole. The locking member is configured to pass through the hole of the at least two locking target units, and the locking member is configured to abut a wall of one of the holes of the locking target units.

### BRIEF DESCRIPTION OF DRAWINGS

FIG. 1 shows a perspective view of a locking device according to the present disclosure;

FIG. 2 shows an exploded view of the locking device of FIG. 1;

FIG. 3 shows a cross-sectional view of the locking device of FIG. 1 in a non-working state;

FIG. 4 shows a cross-sectional view of the locking device of FIG. 1 in a working state;

FIG. 5 shows a cross-sectional view of a sleeve of the locking device of FIG. 1;

FIG. 6 shows a perspective view of a restricting member of the locking device of FIG. 1;

FIG. 7 shows a cross-sectional view of an assembly and a locking device in an unlocked state according to a first embodiment of the present disclosure;

FIG. 8 shows a cross-sectional view of the assembly and the locking device in a locked stated according to the first embodiment of the present disclosure;

FIG. 9 shows a perspective view of another locking device according to the present disclosure;

FIG. 10 shows an exploded view of the locking device of FIG. 9;

FIG. 11 shows a cross-sectional view of the locking device of FIG. 9 in a non-working state;

FIG. 12 shows a cross-sectional view of the locking device of FIG. 9 in a working state;

FIG. 13 shows a cross-sectional view of a sleeve of the locking device of FIG. 9; and

FIG. 14 shows a perspective view of a restricting member of the locking device of FIG. 9.

### DETAILED DESCRIPTION OF THE DRAWINGS

The technical solutions of the embodiments of the present disclosure are described below with reference to the accompanying drawings. Obviously, the described embodiments are only some of the embodiments of the present application, and not all of the embodiments.

### Embodiment 1

In fields such as mechanical engineering and electronic product assembly, the fastening of screws and nuts is a widely used method for fastening. Through the cooperation of screws and nuts, reliable fixing between two or more components can be achieved. The tightening force can be flexibly adjusted according to actual needs. Namely, different tightening forces can be provided by adjusting the number of locking turns between the screw and nut. The fastening structure formed by screws and nuts is inexpensive and suitable for various situations.

However, the fastening process of screws and nuts requires tools such as screwdrivers for assistance, and specific types of screws and nuts also require specific tools, increasing the complexity of the fastening operation and reducing productivity.

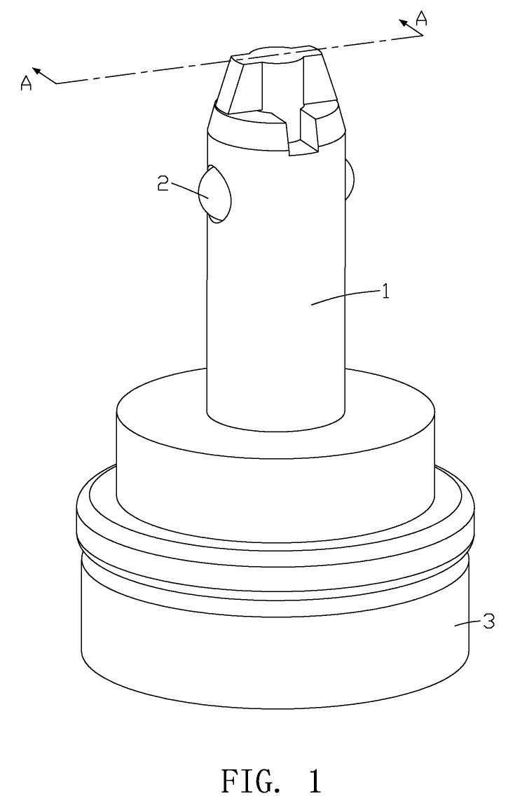

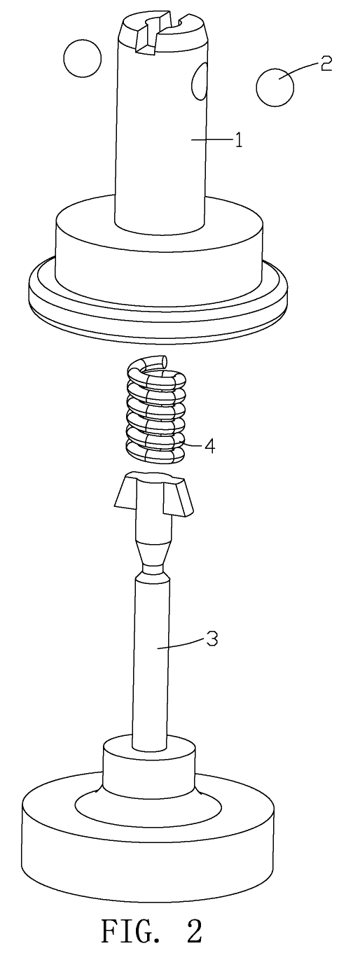

In view of this, the present disclosure provides a locking device 100. Referring to FIGS. 1-8, the locking device 100 is used for a locking process of an assembly 200. The assembly 200 includes at least two lock target units 201 stacked together. Each lock target unit 201 has a hole, and a wall of the hole has a restricting groove 2011.

The locking device 100 includes a sleeve 1, a locking member 2, a restricting member 3, and a resilient member 4. The sleeve 1 has an assembly through hole 11 and a restricting through hole 12. The assembly through hole 11 extends through the sleeve 1 along the axial direction of the sleeve 1. The restricting through hole 12 is formed on a side face of the sleeve 1 and is in fluid communication with the assembly through hole 11. An end face of the sleeve 1 is formed with an accommodating portion 13. The locking member 2 is movably arranged in the restricting through hole 12. The restricting member 3 includes a first guide portion 31 and a restricting protrusion 32 connected to each other. The first guide portion 31 is rotatably arranged in the assembly through hole 11, and at least a portion of the first guide portion 31 connects to the restricting through hole 12. The restricting protrusion 32 contacts the end of the sleeve 1, and the restricting protrusion 32 is configured to move along the end face of the sleeve 1 to the accommodating portion 13 as the restricting member 3 rotates. The resilient member 4 is arranged in the chamber formed by the restricting member 3 and the sleeve 1. The restricting member 4 is configured to apply a force to the sleeve 1, causing the restricting protrusion 32 to move into the accommodating portion 13. The first guide portion 31 is configured to push the locking member 2 in the restricting through hole 12 to move away from the axis of the sleeve 1.

When the locking device 100 is in use, by rotating the restricting member 3, the restricting protrusion 32 can contact different parts of the end face of the sleeve 1, realizing the relative movement between the restricting member 3 and the sleeve 1, such that the first guide portion 31 pushes the locking member 2 to move and abut the wall of the hole of the lock target unit 201, completing the locking process. The locking process does not require additional tools and is simple. Furthermore, the resilient member 4 used in the locking device 100 can be pre-compressed to provide compressive potential energy. When the restricting member 3 rotates to a position where the restricting protrusion 32 corresponds to the accommodating portion13, the resilient member 4 releases the compressive potential energy and applies a force to the sleeve 1. Under this force, the sleeve 1 moves in the direction toward the restricting protrusion 32, causing the restricting protrusion 32 to move into the accommodating portion 13, thereby locking the locking device 100. Different types of resilient members 4 can be selected, allowing the locking device 100 to provide different magnitudes of locking force to meet the different locking force requirements of different devices or equipment.

The following describes some embodiments of the present disclosure in detail with reference to the accompanying drawings. The features in the following embodiments can be combined with each other as long as the combinations do not create conflict.

In some embodiments, when the locking device 100 is assembled, the sleeve 1 engages the hole of the lock target unit 201 of the device or equipment. The shape and size of the locking device 100 can correspond to the hole of the lock target unit 201. For example, when the cross-sectional shape of the hole of the lock target unit 201 is circular, the sleeve 1 can be built as a cylindrical structure; when the cross-sectional shape of the hole of the lock target unit 201 is a regular polygon, the sleeve 1 can be built as a regular polygonal columnar structure. The choice can be made according to practical needs and is not limited hereby.

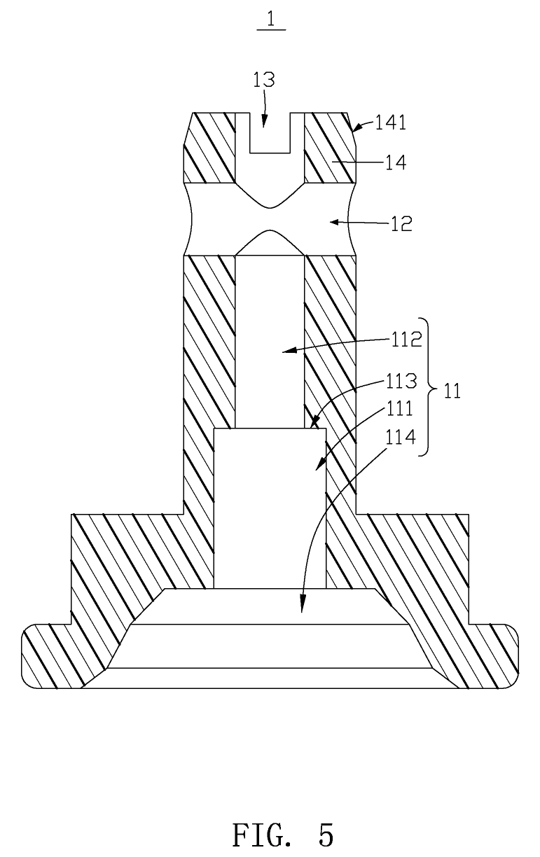

Referring to FIG. 5, the sleeve 1 in the present disclosure is formed by multiple cylindrical structures. Understandably, the cylindrical sleeve 1 has no directional requirements during assembly, allowing for accurate alignment with the hole of the lock target unit 201. This facilitates the installation of the locking device 100 and improves the installation efficiency of the locking device 100. Moreover, the cylindrical surface of the sleeve 1 can evenly distribute the load in the hole, reducing local stress concentration and helping to extend the service life of the locking device 100.

It should be noted that the locking device 100 and the holes of the lock target unit 201 are connected by plugging. The restricting member 3 of the locking device 100 needs to rotate relative to the sleeve 1 during the locking process. If the connection between the sleeve 1 and the holes of lock target unit 201 is unstable, the sleeve 1 will rotate along with the restricting member 3, affecting the locking process of the locking device 100. Therefore, the side face of the sleeve 1 and the hole of the lock target unit 201 of the present disclosure are provided with friction structures (not shown in the figure). Selectively, the friction structures can be a friction protrusion and a friction groove that cooperate with each other. Understandably, after installing the friction structures, during the rotation of the restricting member 3, the sleeve 1 and the hole of the lock target unit 201 do not move relative to each other, and the locking process of the locking device 100 proceeds normally.

Furthermore, referring to FIG. 5, during the assembly process of the locking device 100, the end of the sleeve 1 that first contacts the lock target unit 201 is an assembly end 14. The side face of the assembly end 14 is provided with a second guide portion 141, which is an inclined surface of the side face of the assembly end 14 inclined towards the center of the assembly end 14. Understandably, by providing the second guide portion 141, the diameter of the assembly end 14 of the sleeve 1 is reduced, and the locking device 100 is more easily aligned to the hole of the lock target unit 201 during assembly. Simultaneously, during the assembly of the locking device 100, if the lock device 100 deviates from the assembly direction, the second guide portion 141 can abut against the wall of the hole of the lock target unit 201, guiding the locking device 100 to be assembled in the correct direction into the hole, further speeding up the assembly process of the locking component. The tilt angle of the second guide portion 141 in the present disclosure is selected according to practical needs and is not limited hereby.

Referring to FIG. 5, in some embodiments the sleeve 1 has an axially extending assembly hole 11 inside. The assembly hole 11 includes a first hole segment 111 and a second hole segment 112 connected together. A diameter of the first hole segment 111 is greater than a diameter of the second hole segment 112. The resilient member 4 is fitted into the first hole segment 111, and an abutment portion 113 is formed at the connection between the first hole segment 111 and the second hole segment 112. Understandably, the assembly hole 11 and the abovementioned arrangement of holes facilitate the assembly and pre-compression of the resilient member 4 during the assembly of the locking device 100.

The assembly end 14 of the sleeve 1 has the accommodating portion 13, which is distributed along a radial direction of the assembly end 14 and is formed by receding a portion of the surface of the assembly end 14. The accommodating portion 13 is in fluid communication with the second hole segment 112. The number of accommodating portions 13 in the present disclosure can be limited according to the number of restricting protrusions 32 of the restricting member 3, and can be one or more. Selectively, the present disclosure has two accommodating portions 13, which are symmetrically arranged along a diameter of the sleeve 1. Referring to FIG. 5, in this embodiment, the accommodating portion 13 passes through the side face of the sleeve 1, namely the accommodating portion 13 radially connects the second hole segment 112 to the outside of the sleeve 1.

The side face of the sleeve 1 is formed with restricting through holes 12 passing through in a radial direction and in fluid communication with the second hole segment 112. The number of restricting through holes 12 can be one or more, and they are evenly arranged on the side face. The quantity can be based on locking requirements and is not limited hereby. Selectively, the present disclosure has two restricting through holes 12 on the sleeve 1, both of which are circular holes and symmetrically arranged along the diameter of the sleeve 1.

The restricting through holes 12 are used to assemble the locking member 2. The locking member 2 in the present disclosure is a sphere, and at least part of the restricting through hole 12 has a diameter less than or equal to the diameter of the locking member 2. Understandably, the diameter of at least part of the restricting through hole 12 being less than or equal to the diameter of the locking member 2 prevents the locking member 2 from disengaging from the restricting through hole 12 during use and ensure the structural integrity of the locking device. Specifically, the diameter of at least part of the restricting through hole 12 being less than or equal to the diameter of the locking member 2 restricts the locking member 2 from moving out of the restricting through hole 2 at the side face of the sleeve 1. In some embodiments, the locking member 2 is accommodated into the restricting through hole 12 by first passing through the assembly hole, and then the restricting member 3 is assembled into the assembly hole 11 and restricts the locking member 2 from entering the assembly hole.

It should be noted that in practice, the inner face of the hole of the lock target unit 201 is recessed to form a restricting groove 2011 corresponding to the restricting through hole 12. Understandably, when the locking device 100 is assembled to the locking target unit 201, along the axial direction of the locking device 100, the restricting through hole 12, the locking member 2, and the restricting groove 2011 are at the same height, and when the locking device 100 is switched to the working state, part of the locking member 2 is configured to pass through the restricting through hole 12 and enter the restricting groove 2011.

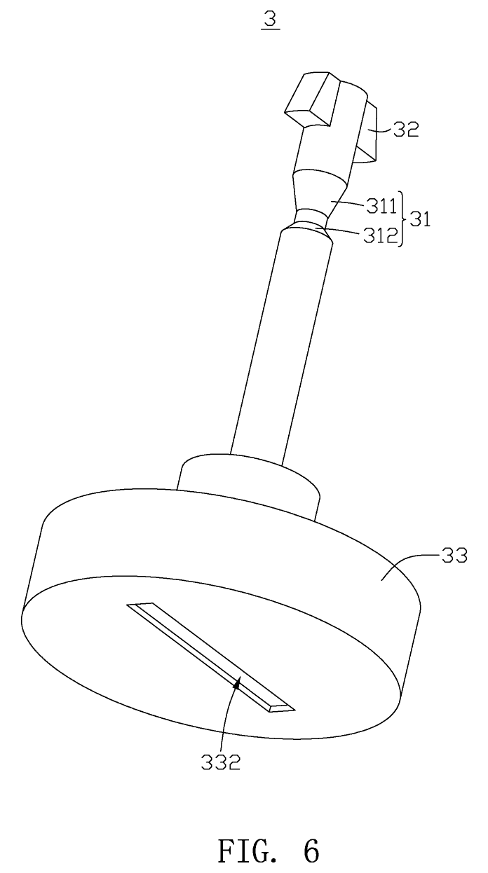

Referring to FIG. 6, in some embodiments, the restricting member 3 of the present disclosure has a columnar structure, and the sleeve 1 sleeves the outer periphery of part of the restricting member 3 through the assembly through hole 11. The side wall of the end of the restricting member 3 is provided with the restricting protrusion 32. When the restricting member 3 and the sleeve 1 are assembled and the locking device 100 is in a non-working state, the restricting protrusion 32 is located outside the sleeve 1 along the axial direction of the restricting member 3, and the bottom face of the restricting protrusion 32 contacts the end face of the assembly end 14 of the sleeve 1. When the locking device 100 switches from a non-working state to a working state, the restricting protrusion 32 rotates on the assembly end 14 until the restricting protrusion 32 is aligned to the accommodating portion 13 of the assembly end 14 of the sleeve 1. At this time, the restricting member 3 and the sleeve 1 move relative to each other, and the restricting protrusion 32 can be wholly or partially accommodated in the accommodating portion 13.

It should be noted that the shape and size of the restricting protrusion 32 in the present disclosure match the shape of the accommodating portion 13 of the sleeve 1, such that part or all of the restricting protrusion 32 can be accommodated in the accommodating portion 13, thereby reducing the lateral or radial dimensions of the locking device. The restricting protrusion 32 and the accommodating portion 13 can be rectangular, trapezoidal, or triangular, etc., and can be selected according to actual needs; no limitation is made herein.

Selectively, referring to FIG. 6, in this embodiment the cross-sectional shape of the restricting protrusion 32 and the restricting portion 13 is approximately a trapezoid.

The side face near the end of the restricting member 3 is also provided with the first guide portion 31 for temporarily storing and applying force to the locking member 2. The first guide portion 31 is recessed from the side face of the restricting member 3 and is in effect after the sleeve 1 and the restricting member 3 are assembled. When the locking device 100 is assembled into the hole of the lock target unit 201, along the axial direction of the locking device 100, the first guide portion 31, the restricting through hole 12, the locking member 2, and the restricting groove 2011 of the hole of the lock target unit 201 are at the same height.

The first guide portion 31 specifically includes a beveled portion 311 and a buffer portion 312. Along the axial direction of the restricting member 3, the beveled portion 311 is positioned closer to the restricting protrusion 32 than the buffer portion 312 is. The beveled portion 311 is inclined from the side face of the restricting member 3 toward the buffer portion 312. Namely, the diameter of the beveled portion 311 decreases in the direction toward the buffer portion 312. Understandably, when the locking device 100 switches from a non-working state to a working state, the restricting member 3 moves relative to the sleeve 1, the beveled portion 311 abuts the locking member 2 and applies force to the locking member 2, pushing part of the locking member 2 through the restricting through hole 12 and into the restricting groove 2011 of the hole of the locking target unit 201; when the locking device 100 switches from a working state to a non-working state, the restricting member 3 moves relative to the sleeve 1, the beveled portion 311 reduces the force applied to the locking member 2, and the temporary storage space formed by the buffer portion 312 can accommodate part of the locking member 2, such that the locking member 2 separates from the restricting groove 2011 of the hole of the locking target unit 201.

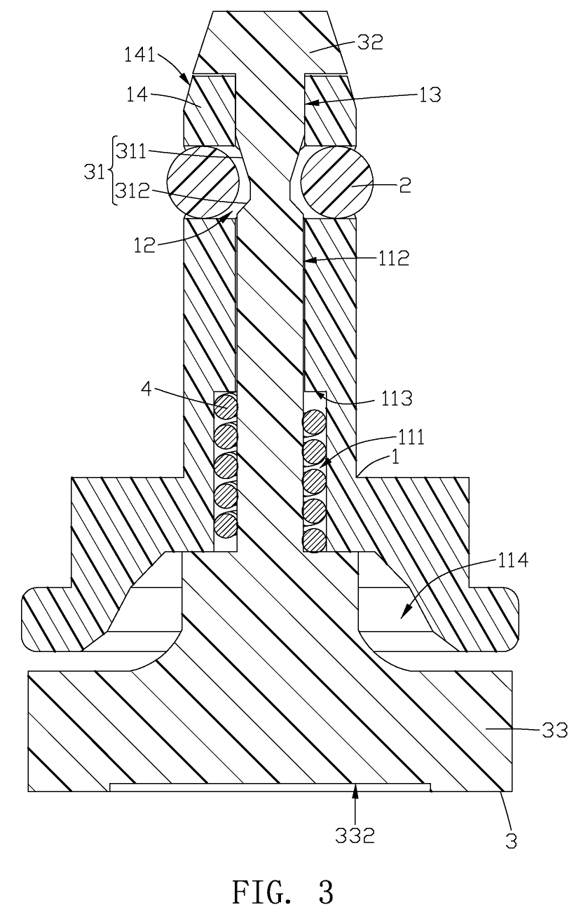

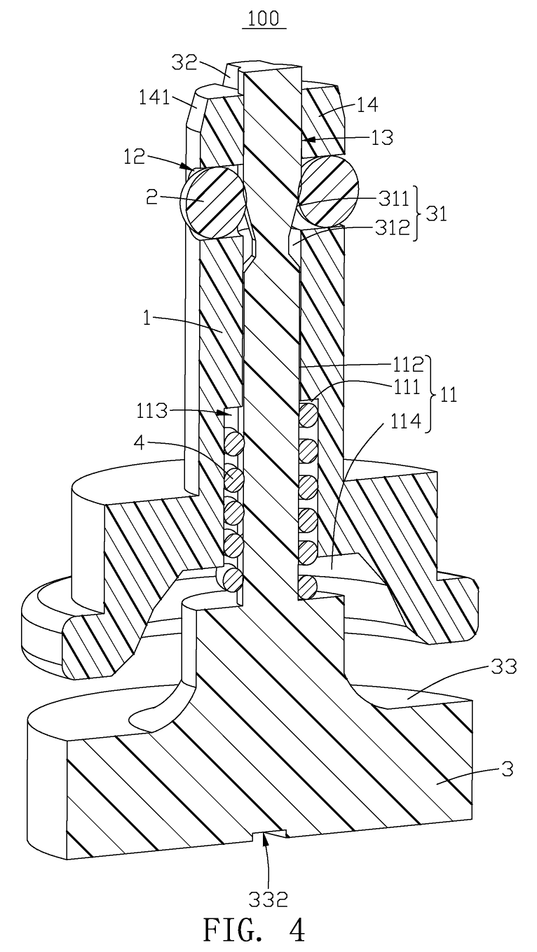

Referring to FIGS. 3 and 4, in some embodiments the relative movement between the restricting member 3 and the sleeve 1 is achieved by the resilient member 4. The resilient member 4 sleeves the outer periphery of the restricting member 3. After the restricting member 3 and the sleeve 1 are assembled, the resilient member 4 is positioned in the first hole section 111 of the sleeve 1. In the present disclosure, the diameter (outer diameter) of the resilient member 4 is greater than the diameter of the second hole segment 112. Namely, the diameters of both the first hole segment 111 and the resilient member 4 are greater than the diameter of the second hole segment 112. Therefore, when the locking device 100 is assembled, the resilient member 4 can abut against the abutment portion 113 and does not enter the second hole segment 112.

At the same time, referring to FIG. 6, the restricting member 3 also includes a base 33. The base 33 is positioned at the end of the restricting member 3 away from the restricting protrusion 32. The base 33 has an assembly protrusion, the diameter of which is greater than the diameters of the first hole segment 111 and the resilient member 4. The other end of the restricting member 3 is connected to the assembly protrusion. Therefore, when the resilient member 4 is assembled onto the outer periphery of the restricting member 3, two ends of the resilient member 4 abut respectively the faces of the abutment portion 113 and the assembly protrusion. Understandably, the base 33 is designed so that when the resilient member 4 is assembled onto the restricting member 3, two ends of the resilient member 4 abut respectively the abutment portion 113 and the assembly protrusion of the base 33. This prevents the resilient member 4 from disengaging the resilient member 3, ensuring the structural integrity of the locking device 100.

It should be noted that in the present disclosure, the base 33 and the restricting member 3 can be an integrally formed structure or a combined structure. The combined structure can include bonding, welding, or assembled connections. Understandably, when the base 33 and the restricting member 3 are an integrally formed structure, bonded, or welded structure, the overall strength of the locking device 100 is high, and the service life is longer. When the base 33 and the restricting member 3 are assembled, assembly of the resilient member 4 is facilitated, and if one of the base 33 and the restricting member 33 is damaged, it can be replaced separately, reducing the maintenance cost of the locking device 100. In some embodiments, the restricting member 3 is inserted into the assembly hole 11 of the sleeve 1 from the assembly end 14, and the base 33 is assembled to the restricting member 3 at the opposite end in the third hole segment 114. Selectively, the base 33 and the restricting member 3 in the present disclosure are an integrally formed structure.

The resilient member 4 used in the present disclosure is a spring, and different types of springs can be selected according to the locking force requirements. It is understood that using a spring as the resilient member 4 allows the spring to provide a relatively constant resilient force within a certain range, ensuring stable performance under different load conditions. Furthermore, after the external force disappears, the spring can quickly return to its original shape, providing an immediate reaction force and accelerating the locking process of the locking device 100. Other types of resilient members 4 can also be used in the present disclosure, such as elastic rubber or elastic silicone.

Furthermore, referring to FIGS. 3 and 4, the assembly through hole 11 of the sleeve 1 also includes a third hole segment 114. The third hole segment 114 connects to the end of the first hole segment 111 away from the second hole segment 112, and a diameter of the third hole segment 114 is greater than a diameter of at least part of the assembly protrusion. Understandably, given that the diameter of the third hole segment 114 is greater than the diameter of at least part of the assembly protrusion, when the locking device 100 is in use, at least part of the assembly protrusion can be accommodated in the third hole segment 114, reducing the axial length of the locking device 100 and thus reducing the overall size of the locking device 100.

Referring to FIG. 6, in some embodiments the base 33 is provided with an orientation structure 332, which is an orientation groove or an orientation protrusion. The cross-sectional shape of the orientation groove or orientation protrusion of the auxiliary tool can be a line or an arrow, etc., and the orientation structure 332 can be selected according to actual needs; no limitation is made herein. Understandably, an orientation structure 332 provided on the base 33 can serve to determine the orientation of the restricting member 3, ensuring the accuracy of the locking process of the locking device 100. Selectively, the pointing structure 332 in the present disclosure is a slotted groove.

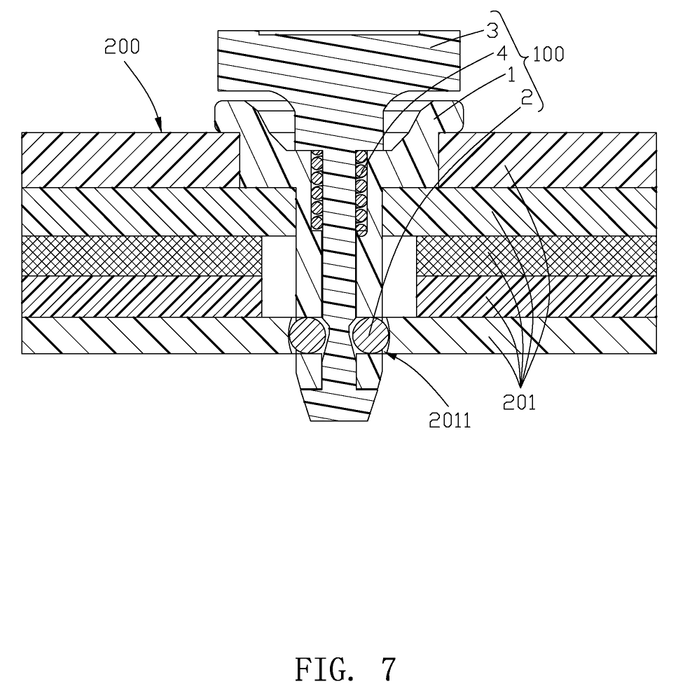

Referring to FIG. 7, in practice the restricting member 3, the sleeve 1, the resilient member 4, and the locking member 2 are assembled to form the locking assembly 100. The restricting protrusion 32 of the restricting member 3 contacts the end face of the assembly end 14 of the sleeve 1, and the resilient member 4 is in a pre-compressed state. At this time, the locking assembly 100 can be assembled into the hole of locking target unit 201. The first guide portion 31, the locking member 2, the restricting through hole 12 are aligned with the restricting groove 2011 of the hole of the locking target unit 201. At this time, the locking device 100 is in a non-working state.

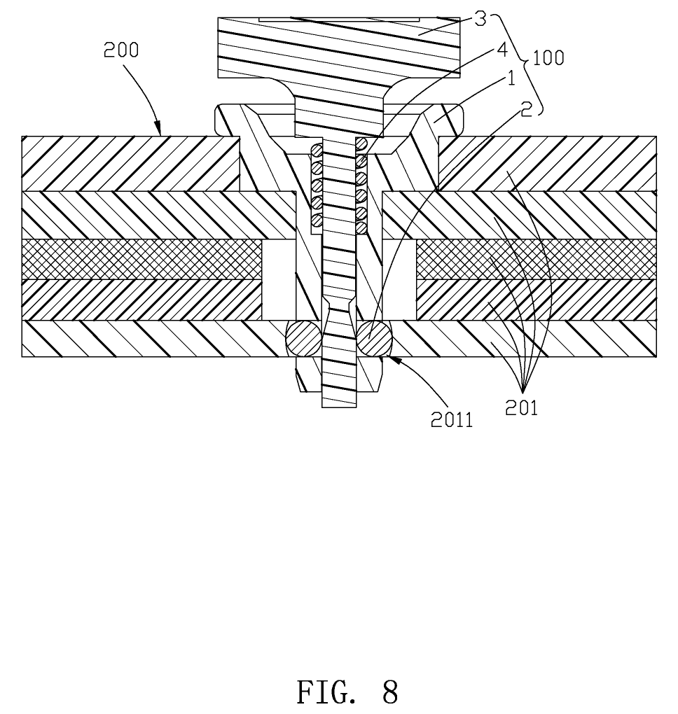

When locking is required, referring to FIG. 8, a force is applied to the restricting member 3 to rotate the restricting member 3. The restricting protrusion 32 rotates on the assembly end 14 of the sleeve 1 until aligning with the accommodating portion 13 of the assembly end 14 of the sleeve 1. The resilient member 4 is released from its compressed state, allowing the restricting member 3 to move relative to the sleeve 1. The restricting protrusion 32 is received in the accommodating portion 13. The beveled portion 311 of the first guide portion 31 abuts the locking member 2 and applies force to the locking member 2. Part of the locking member 2 passes through the restricting through hole 12 and enters the restricting groove 2011 of the hole of the locking target unit 201, completing the locking process of the locking device 100.

When the locking state needs to be released, the base 33 moves relative to and closer to the sleeve 1. The beveled portion 311 releases the force applied to the locking member 2, and the temporary storage space formed by the buffer portion 312 can accommodate part of the locking member 2, causing the locking member 2 to separate from the restricting groove 2011 of the hole of locking target unit 201.

As an optional technical solution of the present disclosure, a plurality of accommodating portions 13 can be provided at the assembly end 14 of the sleeve 1, and the depths of the accommodating portions 13 in the axial direction of the sleeve 1 are different. Understandably, after the restricting protrusion 32 enters the accommodating portion 13, the resilient member 4 can release all or part of its deformation. Depending on the depth of the accommodating portion 13, the restoring deformation of the resilient member 4 varies. Therefore, by selecting accommodating portions 13 of different depths, after the resilient member 4 applies spring force to the sleeve 1, the force exerted by the beveled portion 311 of the first guide portion 31 on the locking member 2 also varies. Thus, the locking device 2 can generate different magnitudes of locking force to meet the requirements for different locking forces of devices or equipment, without needing to replace different types of resilient members 4.

### Embodiment 2

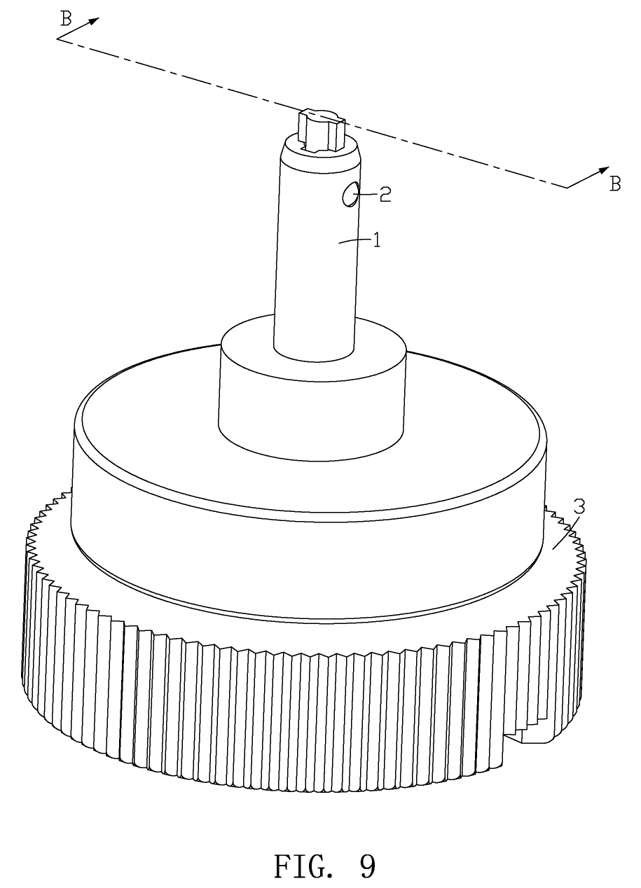

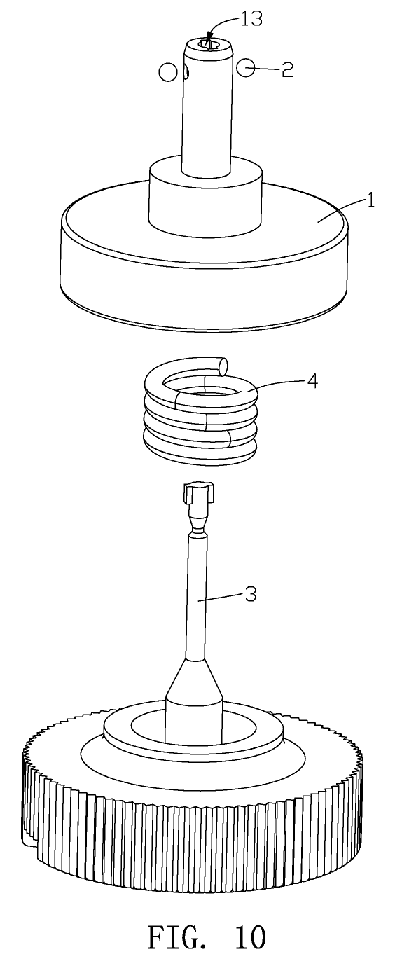

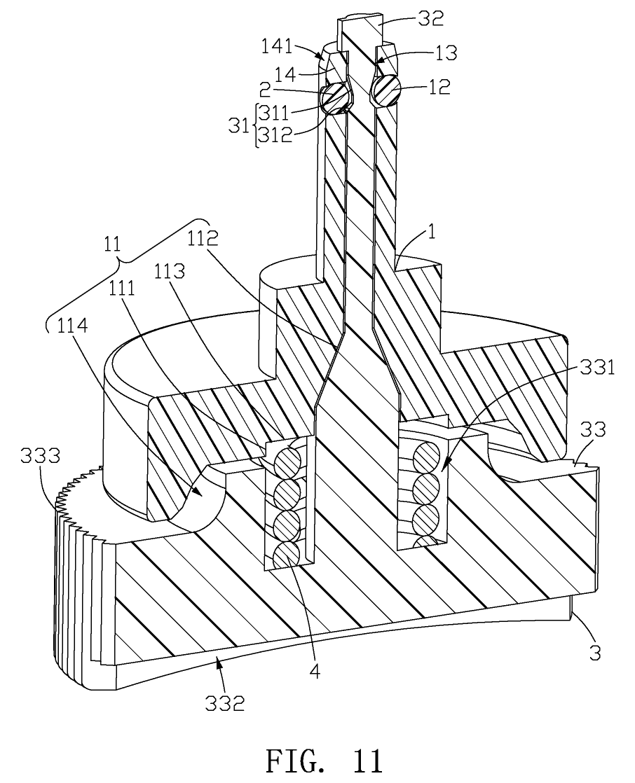

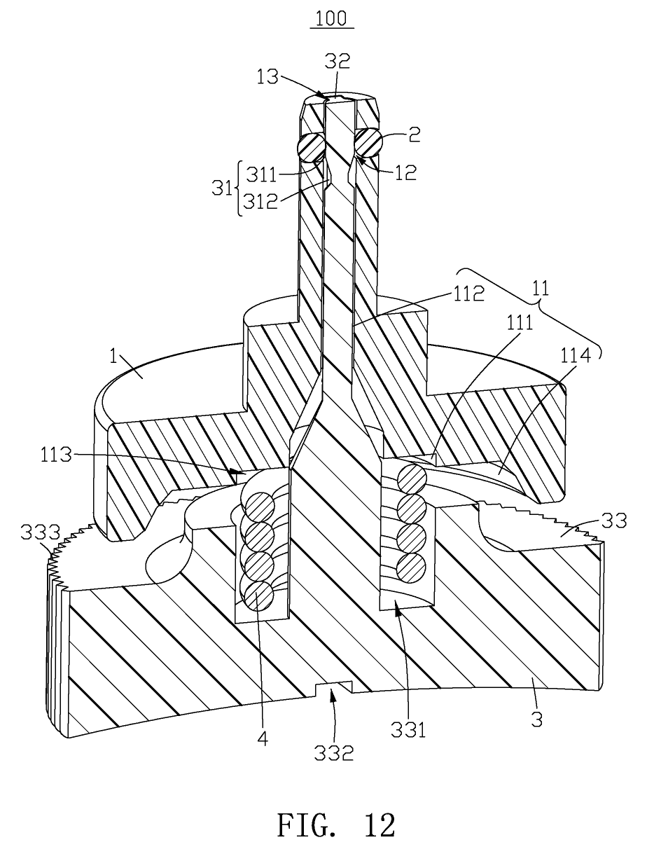

Referring to FIGS. 9-14, different from the first embodiment, the engagement structures between the sleeve 1 and the restricting member 4 are different in the present embodiment.

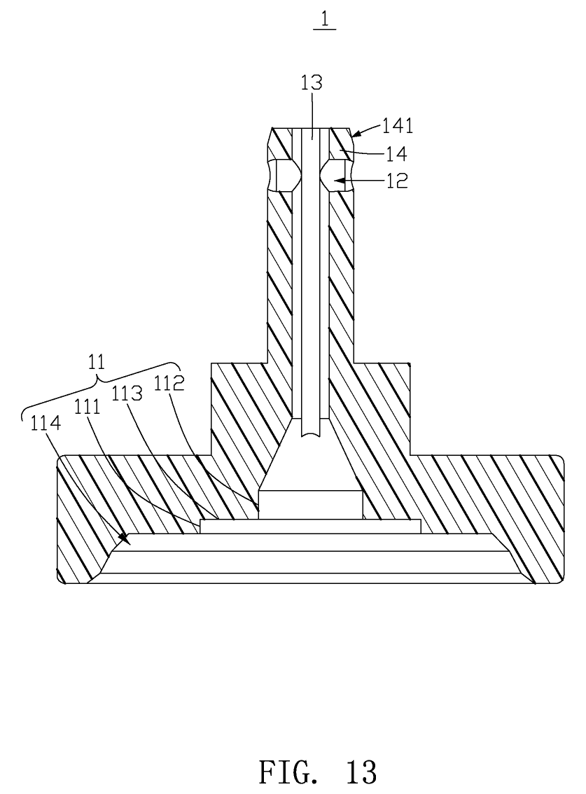

Referring to FIG. 13, in some embodiments the assembly end 14 of the sleeve 1 is provided with the accommodating portion 13. The accommodating portion 13 is arranged radially on the mounting end 14 and is formed by receding a part of the surface of the assembly end 14. The accommodating portion 13 connects to the second hole segment 112. The number of accommodating portions 13 in the present disclosure can be limited according to the number of restricting protrusions 32 of the restricting member 3, and can be one or more. Selectively, the number of accommodating portions 13 in the present disclosure is two, and the two accommodating portions 13 are symmetrically arranged along a diameter of the sleeve 1. In the present embodiment, the accommodating portion 13 only connects to the second hole segment 112, has a roughly rectangular cross-sectional shape, and does not pass through the side face of the sleeve 1

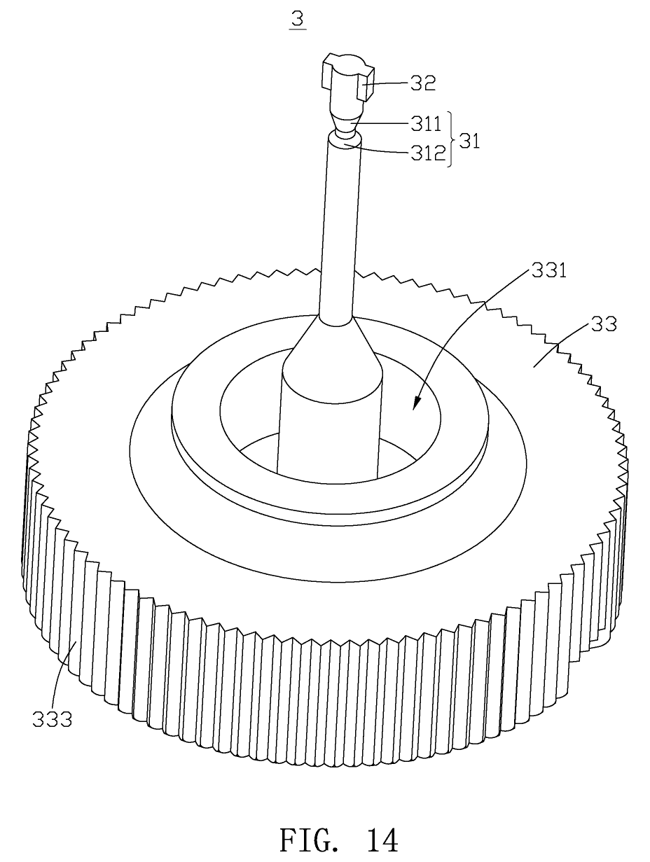

Referring to FIG. 14, in some embodiments the assembly protrusion of the base 33 of the restricting member 3 has an assembly groove 331. At least a portion of the resilient member 4, used to realize the relative movement between the restricting member 3 and the sleeve 1, is accommodated in the assembly groove 331, and the end of the resilient member 4 away from the base 33 abuts the abutment portion 113. Understandably, by receiving the resilient member 4 in the assembly groove 331 of the base 33, and completing processes such as pre-compression and release deformation in the assembly groove 331, the axial length of the locking device 100 can be further reduced.

The side face of the base 33 is provided with an anti-slip structure 333, which can be an anti-slip groove or an anti-slip protrusion. Understandably, the anti-slip structure 333 increases the friction of the side face of the base 33, facilitating gripping of the base 33, accelerating the rotation process of the restricting member 3, and thus improving the locking efficiency of the locking device 100.

In practice, the restricting member 3, the sleeve 1, the resilient member 4, and the locking member 2 are assembled to form the locking device 100. At least a portion of the resilient member 4 is accommodated in the assembly groove 331. The restricting protrusion 32 of the restricting member 3 contacts the end face of the assembly end 14 of the sleeve 1, and the resilient member 4 is in a pre-compressed state. At this time, the locking device 100 can be assembled into the hole of the locking target unit 201. The first guide portion 31, the locking member 2, and the restricting through hole 12 are aligned with the restricting groove 2011 of the hole of the locking target unit 201. At this time, the locking device 100 is in a non-working state.

When locking is required, a force is applied to the restricting member 3 to rotate it. The restricting protrusion 32 rotates on the assembly end 14 of the sleeve 1 until aligning with the accommodating portion 13 of the assembly end 14 of the sleeve 1. The resilient member 4 is released from its compressed state, such that the restricting member 3 moves relative to the sleeve 1. The restricting protrusion 32 is accommodated in the accommodating portion 13. The beveled portion 311 of the first guide portion 31 abuts the locking member 2 and applies a force to the locking member 2. Part of the locking member 2 passes through the restricting through hole 12 and enters the restricting groove 2011 of the hole of the locking target unit 201, completing the locking process of the locking device 100.

When unlocking is required, the base 33 moves relative to and closer to the sleeve 1. The beveled portion 311 releases the force applied to the locking member 2. The temporary storage space formed by the buffer portion 312 can accommodate part of the locking member 2, causing the locking member 2 to separate from the restricting groove 2011 of the hole of the locking target unit 201.

Additionally, those skilled in the art should recognize that the above embodiments merely described the present disclosure, and are not intended to limit the present disclosure. Any appropriate changes and variations made to the above embodiments within the spirit and scope of the present disclosure fall within the scope of the present disclosure.

1. A locking device comprising:
a sleeve having an assembly through hole and a restricting through hole, wherein the assembly through hole extends through the sleeve along an axial direction of the sleeve, the restricting through hole is formed on a side face of the sleeve and is in fluid communication with the assembly through hole, and an end face of the sleeve has an accommodating portion;
a locking member movably assembled in the restricting through hole;
a restricting member comprising a first guide portion and a restricting protrusion connected to each other, wherein the first guide portion is rotatably assembled in the assembly through hole, at least a portion of the first guide portion is aligned to the restricting through hole, the restricting protrusion abuts an end of the sleeve, and the restricting protrusion is configured to rotate on the end face of the sleeve to the accommodating portion as the restricting member rotates; and
a resilient member installed in a chamber formed by the restricting member and the sleeve, wherein the resilient member is configured to apply a force to the sleeve to move the restricting protrusion into the accommodating portion, and the first guide portion is configured to push the locking member to move in the restricting through hole in a direction away from the axis of the sleeve.

2. The locking device according to claim 1, wherein the first guide portion comprises a beveled portion and a buffer portion, the beveled portion is closer to the restricting protrusion than the buffer portion is in the axial direction of the restricting member, the beveled portion is inclined from the side face of the restricting member toward the buffer portion; the beveled portion is configured to
push the locking member to move in the restricting through hole in a direction away from the axis of the sleeve.

3. The locking device according to claim 1, wherein the restricting member further comprises a base, and the base is arranged at an end of the restricting member away from the restricting protrusion; the assembly through hole comprises a first hole segment and a second hole segment connected together, the diameter of the first hole segment is greater than the diameter of the second hole segment, the resilient member is accommodated in the first hole segment, the connection between the first hole segment and the second hole segment forms an abutment portion; and the resilient member is positioned, along the axis of the locking device, between the base and the abutment portion.

4. The locking device according to claim 3, wherein the assembly through hole further comprises a third hole segment, the third hole segment connects to the end of the first hole segment away from the second hole segment, and the diameter of the third hole segment is greater than at least a diameter of a portion of the base, such that at least a portion of the base is accommodated in the third hole segment.

5. The locking device according to claim 3, wherein the base has an assembly groove, at least a portion of the resilient member is accommodated in the assembly groove, and the end of the resilient member away from the base abuts the abutment portion.

6. The locking device according to claim 3, wherein the face of the base away from the restricting through hole is formed with an orientation structure, and the
orientation structure is an orientation groove or an orientation protrusion.

7. The locking device according to claim 3, wherein the side face of the base is formed with an anti-slip structure, and the anti-slip structure is an anti-slip groove or an anti-slip protrusion.

8. The locking device according to claim 1, wherein the locking member is a sphere, and the diameter of at least a portion of the restricting through hole is less than or equal to the diameter of the sphere.

9. The locking device according to claim 1, comprising a plurality of accommodating portions, and the depths of the accommodating portions along the axial direction of the sleeve are different.

10. An assembly comprising:
a locking device comprising:
a sleeve having an assembly through hole and a restricting through hole, wherein the assembly through hole extends through the sleeve along an axial direction of the sleeve, the restricting through hole is formed on a side face of the sleeve and is in fluid communication with the assembly through hole, and an end face of the sleeve has an accommodating portion;
a locking member movably assembled in the restricting through hole;
a restricting member comprising a first guide portion and a restricting protrusion connected to each other, wherein the first guide portion is rotatably assembled in the assembly through hole, at least a portion of the first guide portion is aligned to the restricting through hole, the restricting protrusion abuts an end of the sleeve, and the restricting protrusion is configured to rotate on the end face of the sleeve to the accommodating portion as the restricting member rotates; and
a resilient member installed in a chamber formed by the restricting member and the sleeve, wherein the resilient member is configured to apply a force to the sleeve to move the restricting protrusion into the accommodating portion, and the first guide portion is configured to push the locking member to move in the restricting through hole in a direction away from the axis of the sleeve; and
at least two locking target units stacked together, each locking target unit having a hole; wherein
the locking member is configured to pass through the hole of the at least two locking target units, and the locking member is configured to abut a wall of one of the holes of the locking target units.
